(19) United States
(12) Patent Application Publication
(10) Pub. No.: US 2026/0350802 A1
(43) Pub. Date: Nov. 5, 2026

(54) AGRICULTURAL FIELD ANALYSIS SYSTEM FOR GENERATING A FIELD DIGITAL TWIN

(71) Applicant: IntelinAir, Inc, Indianapolis, IN (US)

(72) Inventors: Greg Rose, Los Angeles, CA (US); Jennifer Hobbs, Champaign, IL (US); David Wilson, Concord, NH (US); Adrian Tudor, Los Angeles, CA (US); Naira Hovakimyan, Champaign, IL (US)

(73) Assignee: IntelinAir, Inc, Indianapolis, IN (US)

(21) Appl. No.: 19/742,876

(22) Filed: Jul. 15, 2026

Related U.S. Application Data
(63) Continuation of application No. 17/992,568, filed on Nov. 22, 2022, now abandoned.
(60) Provisional application No. 63/282,786, filed on Nov. 24, 2021.

(51) Int. Cl. G06T 7/00; G06Q 20/10; G06Q 20/32; G06V 20/10; G06V 20/17

(52) U.S. Cl. CPC G06T 7/0012; G06Q 20/10; G06Q 20/325; G06V 20/17; G06V 20/188; G06T 2207/10032; G06T 2207/30188

(57) ABSTRACT

An aerial analysis system including an image gathering unit that gathers images of a field, an image analysis unit that analyzes images gathered by the image gathering unit, an information display unit that visualizes images identified in the gathered images, an information gathering unit that gathers information related to each gathered image, and a rule unit that generates a digital twin of the field based on the analyzed images and gathered information.

### CROSS REFERENCE TO RELATED APPLICATIONS

This application claims the benefit of and the priority from U.S. Provisional Patent Application No. 63/282,786, filed Nov. 24. 2021, titled AGRICULTURAL FIELD ANALYSIS SYSTEM FOR GENERATING A FIELD DIGITAL TWIN and U.S. Patent Application 17/992,568 filed Nov. 22, 2022, both which are incorporated herein by reference.

### BACKGROUND OF THE INVENTION

The agriculture industry comprises a large portion of the world’s economy. In addition, as the population of the world increases annually, more food must be produced by existing agricultural assets. In order to increase yields on existing plots of farmland, producers require a clear understanding of plant and soil conditions. However, as a single farm may encompass thousands of acres, it is difficult to access the conditions of the farmland.

Currently, farmers rely on their observations of their land along with prior experience to determine the requirements to increase the yield of their farmland. These observations may include identifying locations of weeds, identifying plant illnesses and determining levels of crop damage. However, considering the large number of acres in the average farm, these observations are not a reliable method to increase yields. Therefore, a need exists for system that will allow a farmer to better understand the conditions of their farmland.

### SUMMARY OF THE INVENTION

Systems, methods, features, and advantages of the present invention will be or will become apparent to one with skill in the art upon examination of the following figures and detailed description. It is intended that all such additional systems, methods, features, and advantages be included within this description, be within the scope of the invention, and be protected by the accompanying claims.

One embodiment of the present disclosure includes an aerial analysis system that may have an image gathering unit that gathers images of a field, an image analysis unit that analyzes images gathered by the image gathering unit, an information display unit that visualizes images identified in the gathered images, an information gathering unit that gathers information related to each gathered image, and a rule unit that generates a digital twin of the field based on the analyzed images and gathered information.

In another embodiment, the information gathering unit gathers information on crops grown in the field.

In another embodiment, the information on crops includes soil information.

In another embodiment, the rule unit relates information from the gathered information to gathered images by applying at least one rule to each image.

In another embodiment, the rules applied by the rule unit are specific to each individual field.

In another embodiment, the rules applied by the rule unit are specific to a similar field.

In another embodiment, the information display unit modifies the image based on the rules applied.

In another embodiment, the image analysis unit modifies the image of the field by adjusting at least one piece of information related to the image.

In another embodiment, the image analysis unit determines the type of crop grown in the field.

In another embodiment, the image analysis unit determines the rows of crops from the image of the field.

Another embodiment of the current disclosure includes q method of generating a digital twin of a field, the method including gathering images of a field using an image gathering unit, analyzing the images of the field using an image analysis unit, visualizing the analyzed images using an information display unit, gathering information related to each image using an information gathering unit, and generating a digital twin of the field based on the analyzed images and gathered information.

In another embodiment, the information gathering unit gathers information on crops grown in the field.

In another embodiment, the information on crops includes soil information.

Another embodiment includes the step of relating information from the gathered information to gathered images by applying at least one rule to each image.

In another embodiment, the rules applied by the rule unit are specific to each individual field.

In another embodiment, the rules applied by the rule unit are specific to a similar field.

Another embodiment includes the step of modifying the image based on the rules applied.

In another embodiment, the image analysis unit modifies the image of the field by adjusting at least one piece of information related to the image.

In another embodiment, the image analysis unit determines the type of crop grown in the field.

In another embodiment, the image analysis unit determines the rows of crops from the image of the field.

### BRIEF DESCRIPTION OF THE DRAWINGS

The accompanying drawings, which are incorporated in and constitute a part of this specification, illustrate an implementation of the present invention and, together with the description, serve to explain the advantages and principles of the invention. In the drawings:

FIG. 1 depicts one embodiment of a agricultural analysis system consistent with the present invention;

FIG. 2 depicts one embodiment of a agricultural analysis unit;

FIG. 3 depicts one embodiment of a communication device consistent with the present invention;

FIG. 4 depicts a schematic representation of the components of the agricultural analysis system;

FIG. 5 depicts a schematic representation of a system of processing aerial images to extract information from images of fields;

FIG. 6 depicts a schematic representation of a process used to correlate information related to a field;

FIG. 7 depicts a schematic representation of a process used to correlate equipment used in a field;

FIG. 8 depicts a schematic representation of a process used to verify or correct information gathered from aerial imagery;

FIG. 9 depicts a schematic representation of a process of categorizing fields;

FIG. 10 depicts a schematic representation of a process used to determine an unknown variable in a field;

FIG. 11 depicts a schematic representation of a process to apply a rule to the information related to a field;

FIG. 12 depicts a schematic representation of a process to generate a digital twin image of a field;

FIG. 13 depicts a schematic representation of a process of validating an alert;

FIG. 14 depicts a schematic representation of a process to simulate field conditions using the digital twin of FIG. 12;

FIG. 15 depicts a schematic representation of a process to identify missing field information required to create a digital twin of a field;

FIG. 16 depicts a schematic representation of a process used to identify objects in adjacent images; and

FIG. 17 represents a schematic representation of a machine learning process used to analyze images.

### DETAILED DESCRIPTION OF THE INVENTION

Referring now to the drawings which depict different embodiments consistent with the present invention, wherever possible, the same reference numbers will be used throughout the drawings and the following description to refer to the same or like parts.

The agricultural analysis system 100 gathers high to low resolution images from an aircraft flying above 1,500 feet. In one embodiment, the image is a multi-spectral image. The images are processed using various processing methodologies to determine a plurality of characteristics of a field including, but not limited to, the type of crop planted, number of rows, amount of weeds and any other characteristic of the field. Field observations, equipment operations and weather data is gathered and correlated with the field. By storing multiple images of fields over time, numerous profiles can be generated for each field. In addition, each field can be categorized and subcategorized to allow for correlations to be made between fields in different geographical locations and times.

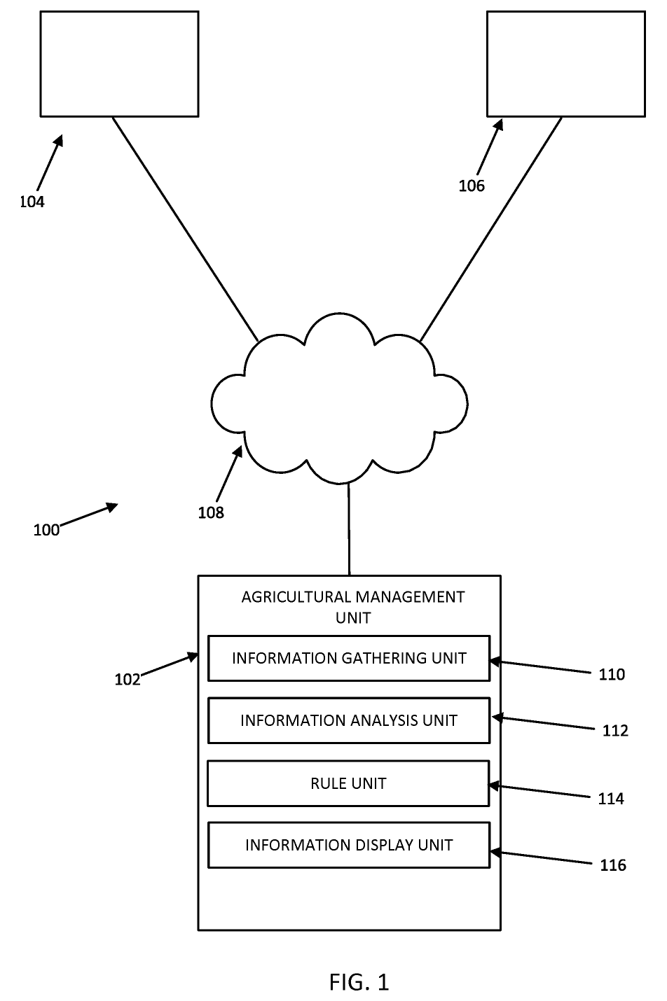

FIG. 1 depicts one embodiment of a agricultural analysis system 100 consistent with the present invention. The agricultural analysis system 100 includes an agricultural analysis unit 102, a communication device 1 104, a communication device 2 106 each communicatively connected via a network 108. The agricultural analysis unit 102 further includes an information gathering unit 110, an information analysis unit 112, a rule unit 114 and an information display unit 116.

The information gathering unit 110 and information analysis unit 112 may be embodied by one or more servers. Alternatively, each of the rule unit 114 and information display unit 116 may be implemented using any combination of hardware and software, whether as incorporated in a single device or as a functionally distributed across multiple platforms and devices.

In one embodiment, the network 108 is a cellular network, a TCP/IP network, or any other suitable network topology. In another embodiment, the row identification device may be servers, workstations, network appliances or any other suitable data storage devices. In another embodiment, the communication devices 104 and 106 may be any combination of cellular phones, telephones, personal data assistants, or any other suitable communication devices. In one embodiment, the network 102 may be any private or public communication network known to one skilled in the art such as a local area network (“LAN”), wide area network (“WAN”), peer-to-peer network, cellular network or any suitable network, using standard communication protocols. The network 108 may include hardwired as well as wireless branches. The information gathering unit 112 may include a digital camera.

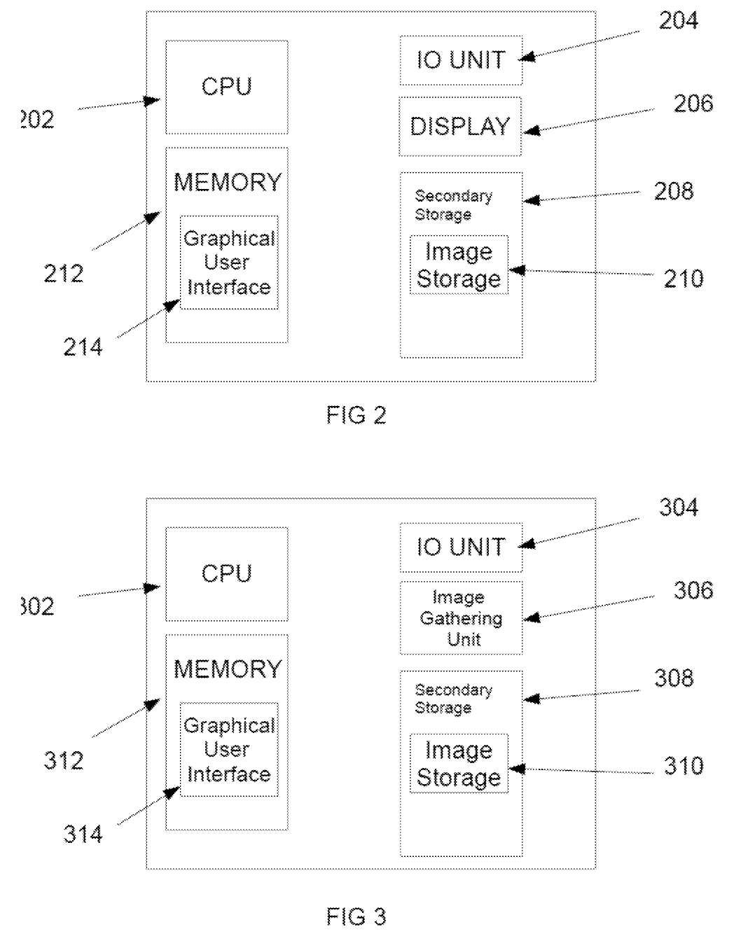

FIG. 2 depicts one embodiment of a agricultural analysis unit 102. The agricultural analysis unit 102 includes a network I/O device 204, a processor 202, a display 206 and a secondary storage 208 running image storage unit 210 and a memory 212 running a graphical user interface 214. The image gathering unit 112, operating in memory 208 of the agricultural analysis unit 102, is operatively configured to receive an image from the network I/O device 204. In one embodiment, the processor 202 may be a central processing unit (“CPU”), an application specific integrated circuit (“ASIC”), a microprocessor or any other suitable processing device. The memory 212 may include a hard disk, random access memory, cache, removable media drive, mass storage or configuration suitable as storage for data, instructions, and information. In one embodiment, the memory 208 and processor 202 may be integrated. The memory may use any type of volatile or non-volatile storage techniques and mediums. The network I/O line 204 device may be a network interface card, a cellular interface card, a plain old telephone service (“POTS”) interface card, an ASCII interface card, or any other suitable network interface device. The rule unit 114 may be a compiled program running on a server, a process running on a microprocessor or any other suitable port control software.

FIG. 3 depicts one embodiment of a communication device 104/106 consistent with the present invention. The communication device 104/1106 includes a processor 302, a network I/O Unit 304, an image capture unit 306, a secondary storage unit 308 including an image storage device 310, and memory 312 running a graphical user interface 314. In one embodiment, the processor 302 may be a central processing unit (“CPU”), an application specific integrated circuit (“ASIC”), a microprocessor or any other suitable processing device. The memory 312 may include a hard disk, random access memory, cache, removable media drive, mass storage or configuration suitable as storage for data, instructions, and information. In one embodiment, the memory 312 and processor 302 may be integrated. The memory may use any type of volatile or non-volatile storage techniques and mediums. The network I/O device 304 may be a network interface card, a plain old telephone service (“POTS”) interface card, an ASCII interface card, or any other suitable network interface device.

In one embodiment, the network 108 may be any private or public communication network known to one skilled in the art such as a Local Area Network (“LAN”), Wide Area Network (“WAN”), Peer-to-Peer Network, Cellular network or any suitable network, using standard communication protocols. The network 108 may include hardwired as well as wireless branches.

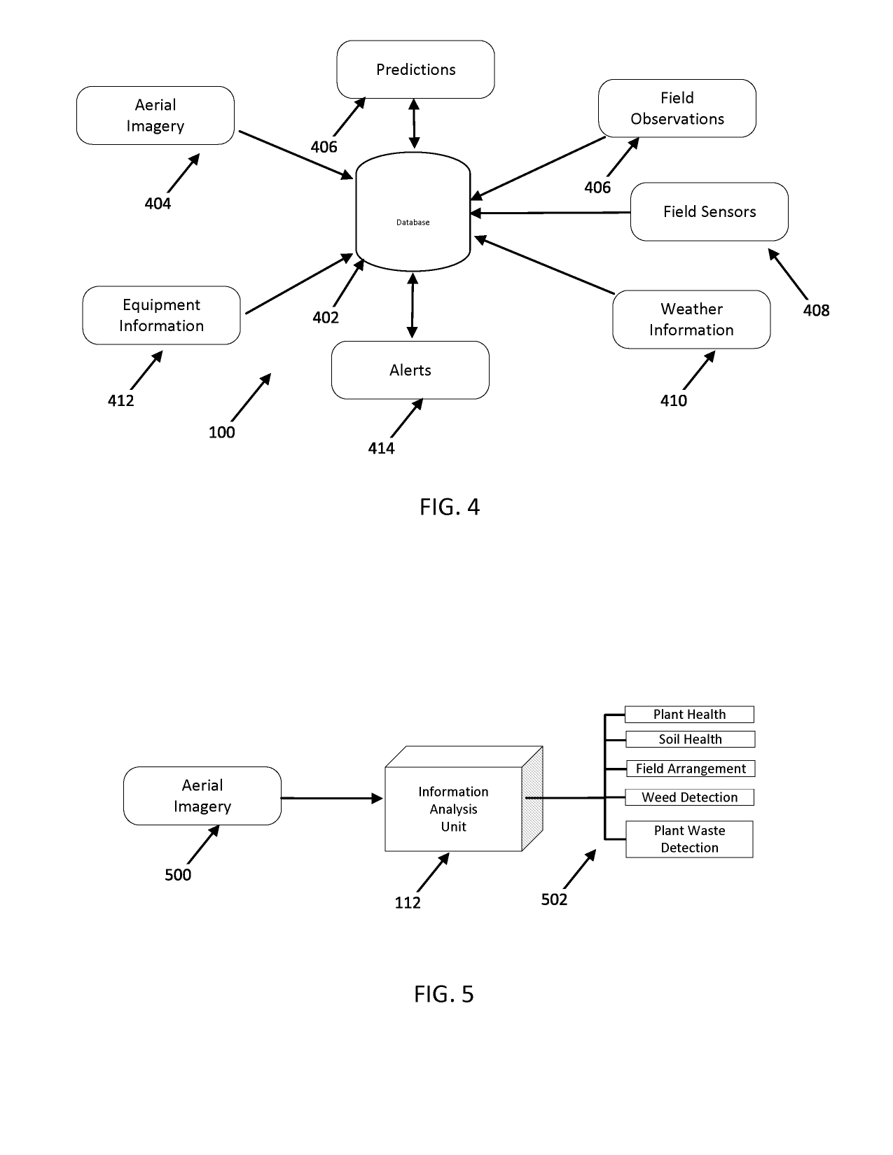

FIG. 4 depicts a schematic representation of the components of the agricultural analysis system 100. The agricultural analysis system 100 includes a central database 402 that collects information from a plurality of sources. Aerial imagery 404 is gathered from external sources including aircraft, drones, satellite images or any other aerial imagery source. Field observations 406 are gathered from individuals working in the fields. In one embodiment, the field observations are uploaded to the database 402 by workers working in a specific field. Field sensors 408 send information on soil conditions, water levels, environmental information and other measurable field information to the database 402. Weather information 410 is gathered from third party sources. Weather information 410 may include, but is not limited to, rain levels, winds, sun exposure, humidity, temperatures and any other weather data. Equipment information is transmitted to the database 402 from equipment working a specific field. Equipment information may include, but is not limited to, equipment run time, speed, function, amount of discharge of product to the field and the location of the equipment in the field. In one embodiment, the equipment may include a camera that gathers high resolution images of the crops in the field. All information gathered by the database is related to the geographic location of the field.

The agricultural management unit 102 analyzes the information in the database to determine additional information for a field that is not directly measured. Using this information from the agricultural management unit 102, the agricultural management unit 102 generates alerts that are transmitted to the party managing the field. In addition, the agricultural management unit 102 can make predictions on processes used in working the field and also in the overall yield of the field.

FIG. 5 depicts a schematic representation of a system of processing aerial images to extract information from images of fields. The aerial images 500 are gathered from aircraft or drones or satellite flying over the fields at an altitude of at least 1,500 feet above a field. The information analysis unit 112 applies a series of masks machine learning based models, computer vision algorithms and mathematical formulas to extract information form the aerial images and outputs the information 502 to the database 402. The information 502 may include the health of the plants in the field, areas of active management, the soil conditions of the field, the arrangement of plants in the field, such as the arrangement, spacing and number of rows of plants in the field, the amount of weeds in the field and the amount of residual plant waste left in the field. In one embodiment, the information analysis unit 112 analyzed an image of a large area to determine the metes and bounds of parcels of land. In one embodiment, the information analysis unit 112 utilizes machine learning to determine the metes and bounds of a parcel. In another embodiment, information on the metes and bounds of a parcel are uploaded to the information analysis unit 112. In another embodiment, the image analysis unit 112 gathers information from a Geographical Information System based on the location information associated with each image.

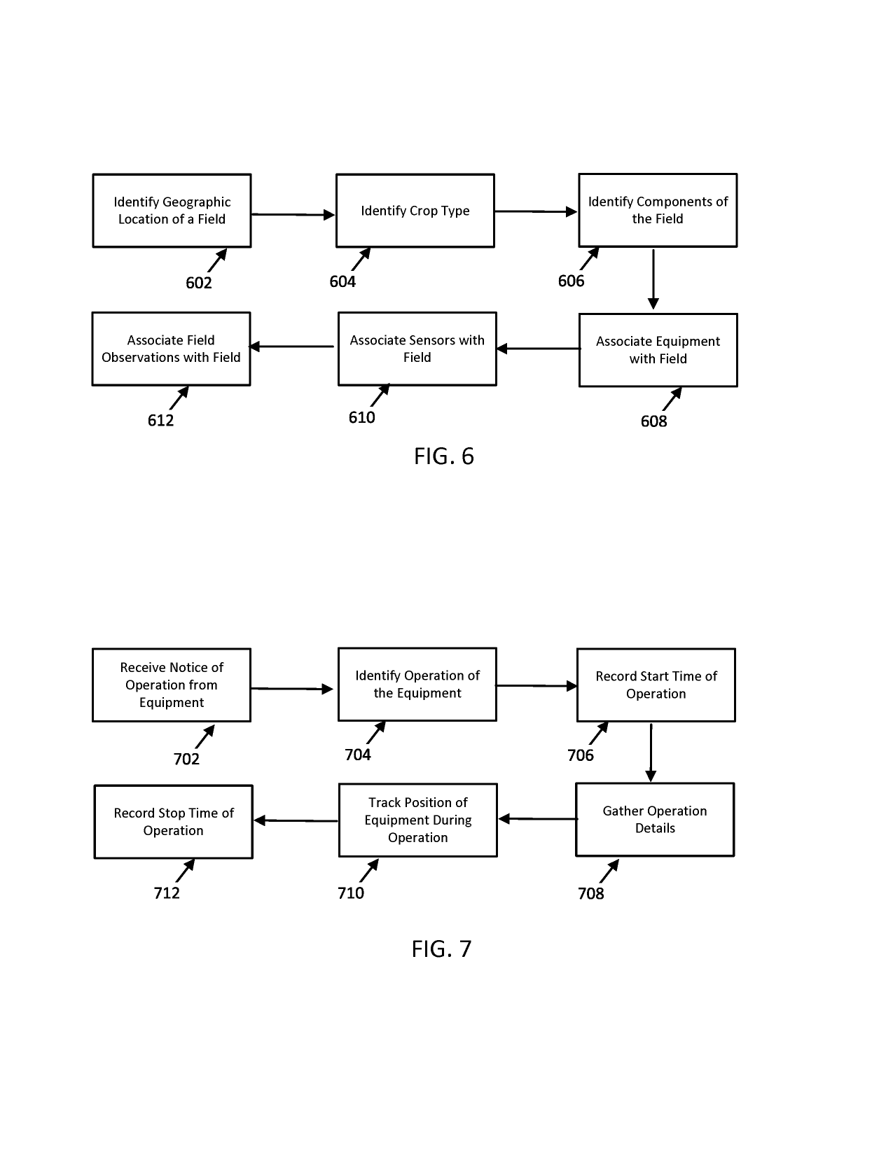

FIG. 6 depicts a schematic representation of a process used to correlate information related to a field. In step 602, the geographic location of the field is identified. The geographic location may include, but is not limited to, the boundaries of the field, the GPS location of the boundaries of the field, the size of the field and any other geographic location indicators. In step 604, the type of crop grown in the field is identified. The type of crop may be identified by analyzing the aerial image. In another embodiment, the type of crop is identified by a physical observation of the field. In another embodiment, the type of crop is identified through the uploading of equipment data. In step 606, components of the field are extracted from the aerial images using the process described in FIG. 5. In step 608, any equipment used in the field that is transmitting information to the database 402 is added to the database. In step 610, the sensors are associated with the field. In step 612, field observations are associated with the field. In one embodiment, the identities of individuals are associated with the field.

FIG. 7 depicts a schematic representation of a process used to correlate equipment used in a field. In step 702, an indication of operation is received from the equipment. The indication may be a wireless signal sent from the equipment to the agricultural analysis unit 102. In step 704, the type of operation is identified. The type of operation indicates what operation the equipment will be used for during the operation. In one embodiment, the type of operation of the equipment is transmitted from the equipment to the agricultural analysis unit 102. In another embodiment, the type of operation of the equipment is transmitted to the agricultural analysis unit 102 by an observer. In step 706, the start date and time of the operation is recorded. In step 708, the information gathering unit 112 continuously gathers information from the equipment. The information gathering unit 112 may gather the speed the equipment is operating, discharge rates of any product discharged from the equipment, operational characteristics of the engine or any other information related to the equipment. In step 710, the information gathering unit 112 tracks the path of the equipment through the field. In one embodiment, the equipment transmits the position of the equipment in the field to the information gathering unit 112 using GPS coordinates. In step 712, the stop time of the operation of the equipment is recorded.

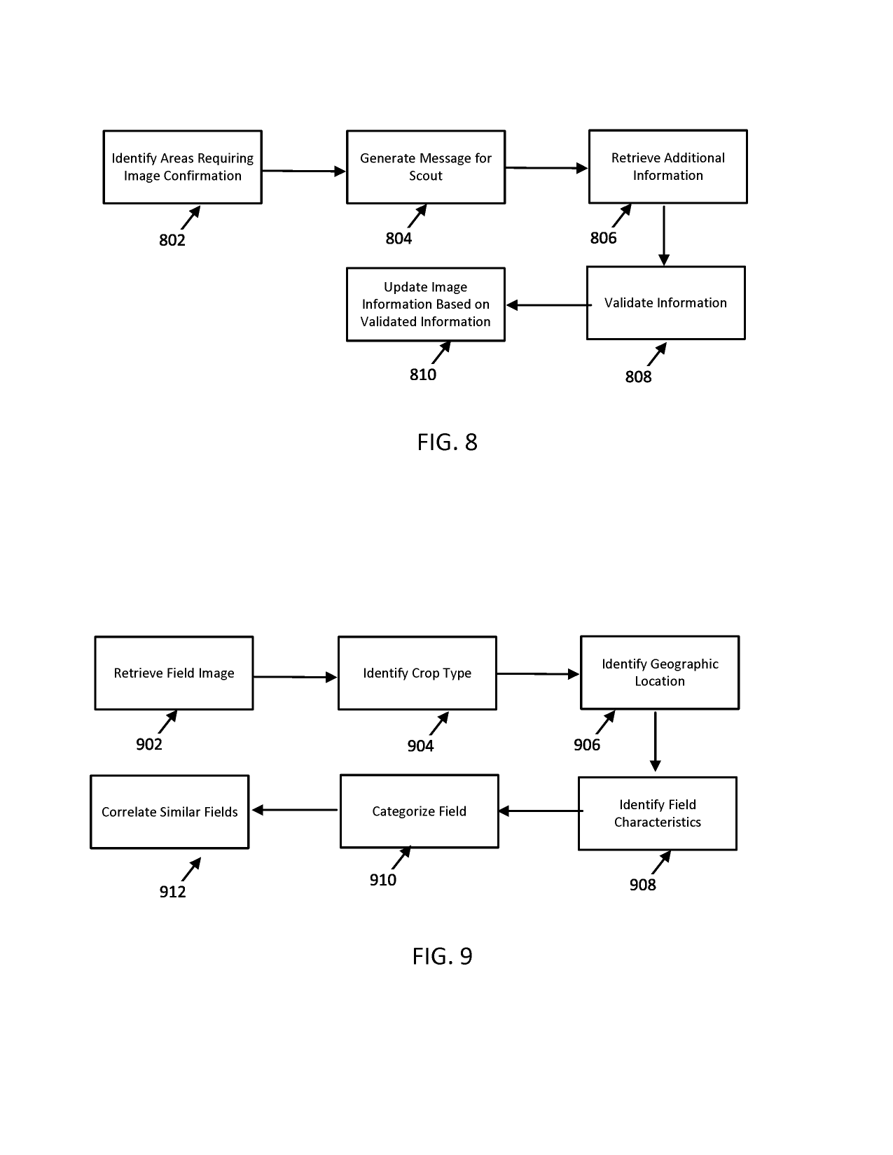

FIG. 8 depicts a schematic representation of a process used to verify or correct information gathered from aerial imagery. In step 802, areas for confirmation are identified using geographic coordinates. The areas used for confirmation may include areas in the aerial imagery including information that was unknown and areas in the aerial imagery where the information is known and requires confirmation. In step 804, a message is generated and transmitted to an individual in the field. In one embodiment, the individual receives the message on a communication device 104/106 when the induvial is in proximity of the field. In another embodiment, the information is preloaded onto a communication device before the individual enters the field. In step 806, the information is transferred to the information gathering unit 112 and is used to update the characteristics of the field to enhance the accuracy of the analysis of the aerial imagery. In one embodiment, the user in the field gathers additional images using image gathering applications. As an illustrative example, a user may execute an application on a mobile communication device 104/106 that gathers and analyzes images taken by the user of specific objects, such as an ear of corn. In another embodiment, the application gathers location information of the user for later incorporation of the gathered data into the location associated with the aerial images.

FIG. 9 depicts a schematic representation of a process of categorizing fields. In step 902, an arial image of a field to be categorized. In step 904, the type of crop being grown in the field is identified. In step 906, the geographic location of the field is identified. In step 908, the characteristics of the filed are identified. In step 910, the information analysis unit 112 categorizes the field based on the type of crop grown on the field, the geographic location and the field characteristics. In step 912, the information analysis unit 112 correlates relationships between the fields based on the crop grown, geographic location and the field characteristics.

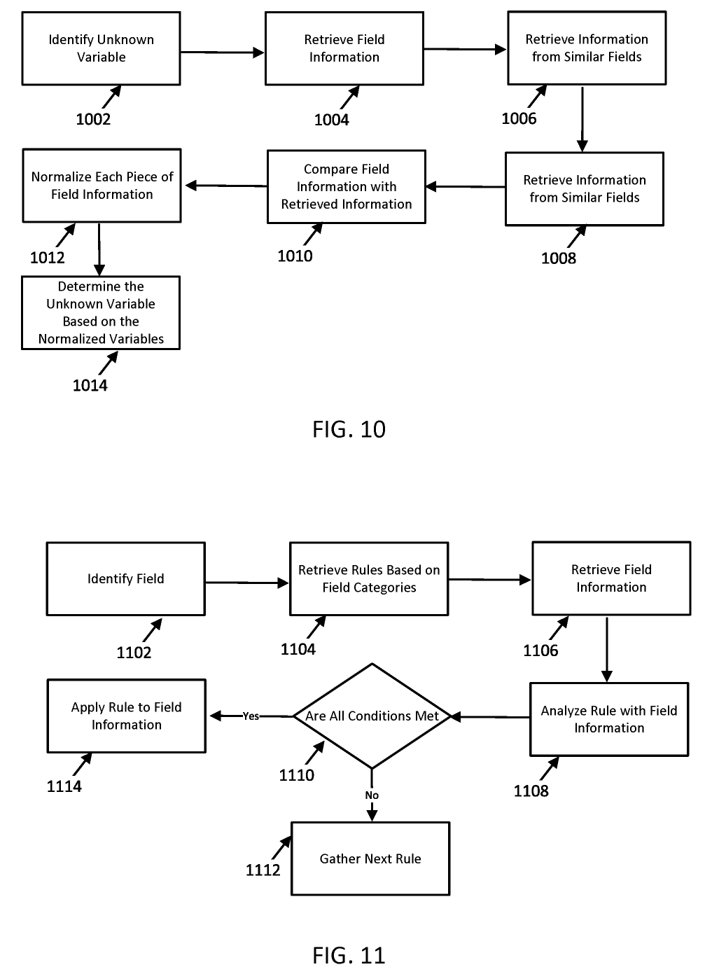

FIG. 10 depicts a schematic representation of a process used to determine an unknown variable in a field. In step 1002, an unknown variable of a field is identified. In step 1004, the information associated with the field is retrieved along with the categorizations of the fields. In step 1006, the information analysis unit 112 identifies similar fields. The similar fields may be any field in a same category of the field. In step 1008, the information analysis unit 112 retrieves the information for each similar field. In step 1010, the information analysis unit 112 compares the unknown information with known information in each similar field. In step 1012, the information analysis unit 112, normalizes the known values. In step 1014, the information analysis unit 112 generates a value based on the normalized values.

FIG. 11 depicts a schematic representation of a process to apply a rule to the information related to a field. In step 1102, a field to apply a rule to is identified. In step 1104, a plurality of rules is retrieved based on the categories associated with the field. In step 1106, the information related to the field is retrieved from the database 402. In step 1108, the rule analysis unit 114 analyzes the rule to determine the information and associated thresholds. In step 1110, the rule analysis unit 114 determines field information includes all information and thresholds required to apply the rule to the field information. In step 1112, the rule analysis unit 114 retrieves the next rule from the plurality of rules if the field information does not include the required information or the field information is outside the required threshold for the rule. In step 1114, the rule analysis unit 114 applies the rule if all conditions of the rule are satisfied. In applying the rule, the rule may generate an alert to a user, modify the threshold of an associated rule, modify the display for a user or perform any other function.

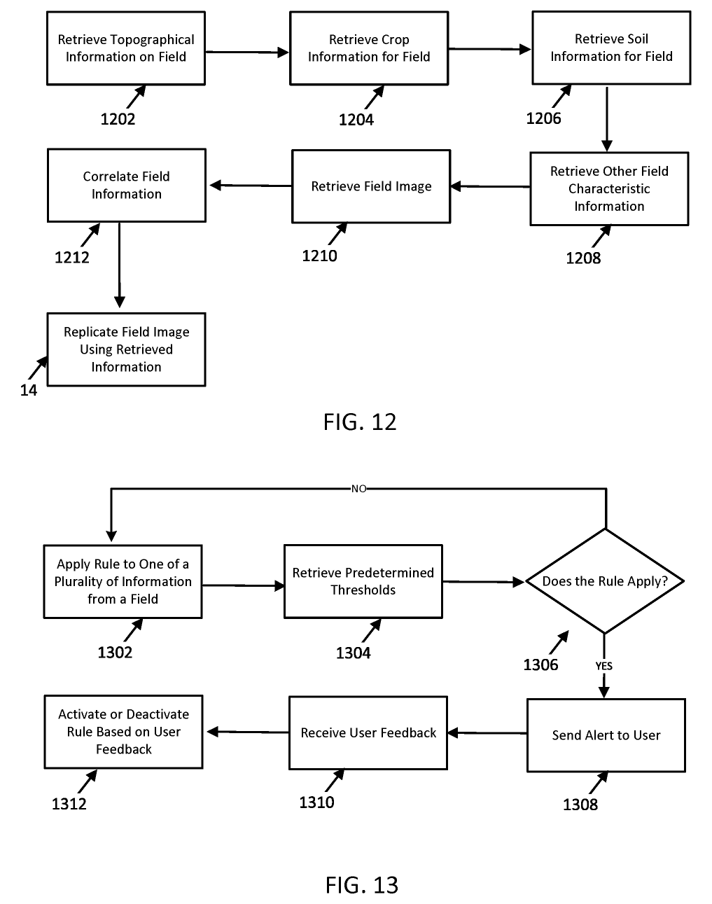

FIG. 12 depicts a schematic representation of a process to generate a digital twin image of a field. In step 1202, topographical information related to a field is retrieved. The topographical information may include field boundaries, elevations across the field, bodies of water, the grade of different areas in the field and any other topographical information related to the field. In step 1204, crop information for the field is retrieved. The crop information may include, but is not limited to, the type of crop, the number and arrangement of rows, weed coverage, field anomalies, vegetation coverage, and any other information on the crop. In step 1206, soil information is retrieved for the field. The soil information may include, but is not limited to, the soil moisture level, the compaction of the soil, the soil nutrient levels and any other soil information. In step 1208, additional field information is gathered. The additional information may include, but is not limited to, locations of debris, locations of tress and other objects, amount of rain received by the field, amount of sun received by the field or any other information related to the field. In step 1210, a representative image of the field is retrieved. In step 1212, each piece of field information n is related to other pieces of field information by applying rules to the information that result in each piece of information being logically related to at least one other piece of information. In one embodiment, the rules are specific to the individual field. In another embodiment, the rules are related to similar fields. In step 1214, the representative image is modified based on the field information and the correlations. In one embodiment, each piece of information gathered is converted into an object that is overlaid on the representative image. In another embodiment, the image is modified to reflect at least one piece of information. After all information is applied to the image, the image represents a digital representation of the field. By adjusting one or more variables, the digital representation of the field will react in a similar manner as the field in real life allowing for simulations [or other predictive models] to be run on the field representation to determine potential yield or other outcomes.

FIG. 13 depicts a schematic representation of a process of validating an alert. In step 1302, a rule is applied to at least one piece of information related to a field or a piece of equipment related to the field. In step 1304, predetermined thresholds for information associated with the rule is retrieved. In step 1306, the predetermined thresholds are compared to corresponding pieces of information related to a field. If the corresponding values satisfy the predetermined threshold, an alert to a user in step 1308. If the corresponding value does not satisfy the predetermined threshold, a new rule is selected in step 1302. The user may receive the alert using any known method of transferring alerts including, but not limited to, emails, text messages, phone calls or any other method of transmitting an alert. In step 1310, as part of the alert, the user is asked to acknowledge whether the alert provided useful information. In step 1312, the alert and associated rule is left active if positive feedback is received from the user and the alert and associated rule are deactivated for the field if negative feedback is received.

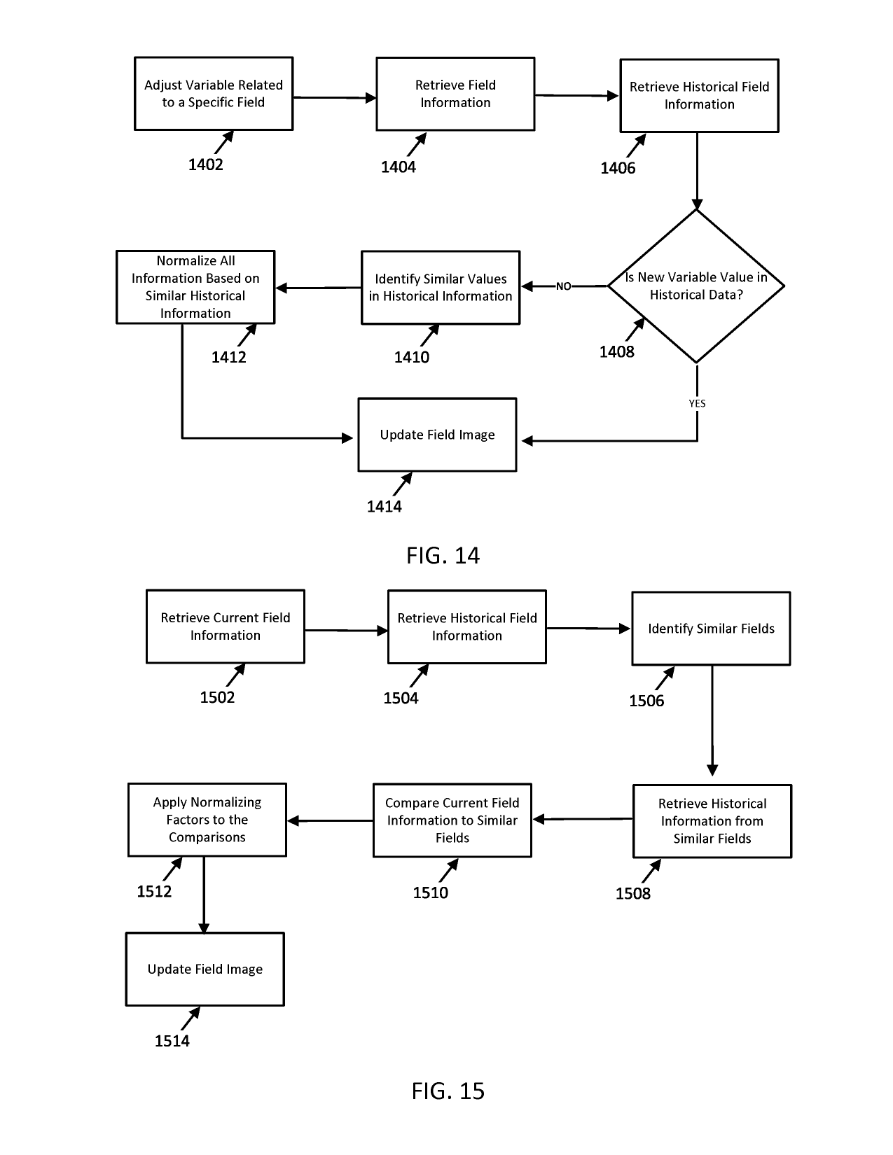

FIG. 14 depicts a schematic representation of a process to simulate field conditions using the digital twin of FIG. 12. In step 1402, at least one piece of information related to the field is adjusted to a new value. In step 1404, information related to the field is retrieved. In step 1406, historical information related to the field is retrieved. In step 1408, the information analysis unit 112 determines if the new value of the adjusted information resides in any historical information. If the new value of the adjusted information is in the historical data, the field values are retrieved from the historical data and the field image is updated in step 1414. In step 1410, if the new value of the adjusted information does not reside in the historical data, the information analysis unit 112 analyzes the historical data to identify values similar to the adjusted value of the information. In step 1412, the current field information values that were not adjusted are normalized based on the historical field information identified as having similar values to the adjusted information value. In step 1414, the field image is modified based on the normalized values. In one embodiment, the field image is transmitted to an augmented/virtual reality engine that creates a augmented or virtual reality experience that displays the gathered information as part of the augmented or virtual reality interface. As one having ordinary skill in the art, will understand, by gathering information over a series of consecutive weeks, months and years, the accuracy of field calculations increases.

FIG. 15 depicts a schematic representation of a process to identify missing field information required to create a digital twin of a field. In step 1502, current field information, including information with adjust values, are retrieved. In step 1504, historical information for the field is retrieved. In step 1506, similar fields are identified. In identifying similar fields, the crop type, geographic location, soil conditions and other field information is compared to information for a plurality of fields. The information analysis unit 112 filters field information to identify similar fields. In step 1508, historical information is retrieved for the similar fields. In step 1510, the current field information is compared to each similar field to identify similarities and differences in the information. In step 1512, a normalizing factor is applied to the field information based on the similar field current and historical information. In step 1514, the image is updated based on the normalized field information.

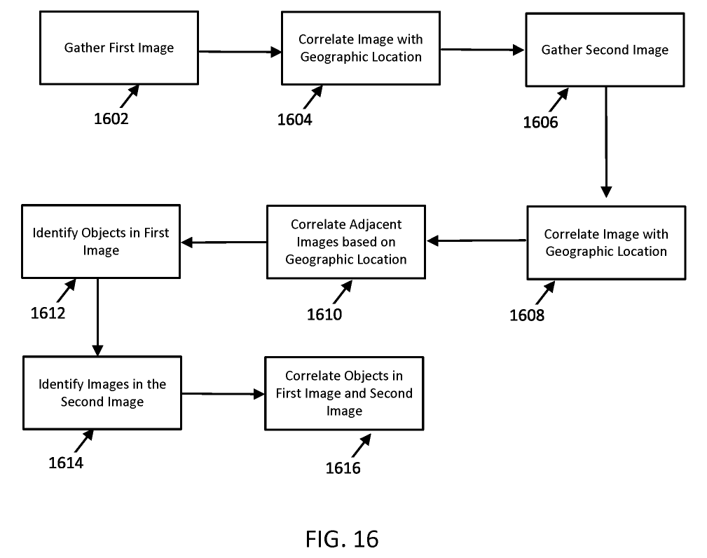

FIG. 16 depicts a schematic representation of a process used to identify objects in adjacent images. In step 1602, a first image is gathered from memory or from an image gathering unit. In step 1604, the image is correlated with the geographic location of the image. In one embodiment, the central portion of the image is used to define the geographic location. In another embodiment, the edges of the image are used to define the geographic location. In step 1606, a second image is gathered. In step 1608, the geographic location of the second image is correlated with the second image. In one embodiment, the central portion of the image is used to define the geographic location. In another embodiment, the edges of the image are used to define the geographic location. In step 1610, the first image is correlated with the second image based on the geographic location of the first image. In one embodiment, the edges of the first and second images with similar geographical locations are logically related. In step 1612, the first image is analyzed to identify objects in the image. In step 1614, the second image is analyzed to identify objects in the second image. In step 1616, the information analysis unit 112 correlates objects in the first image with objects in the second images based on the geographic location of the first image and second image.

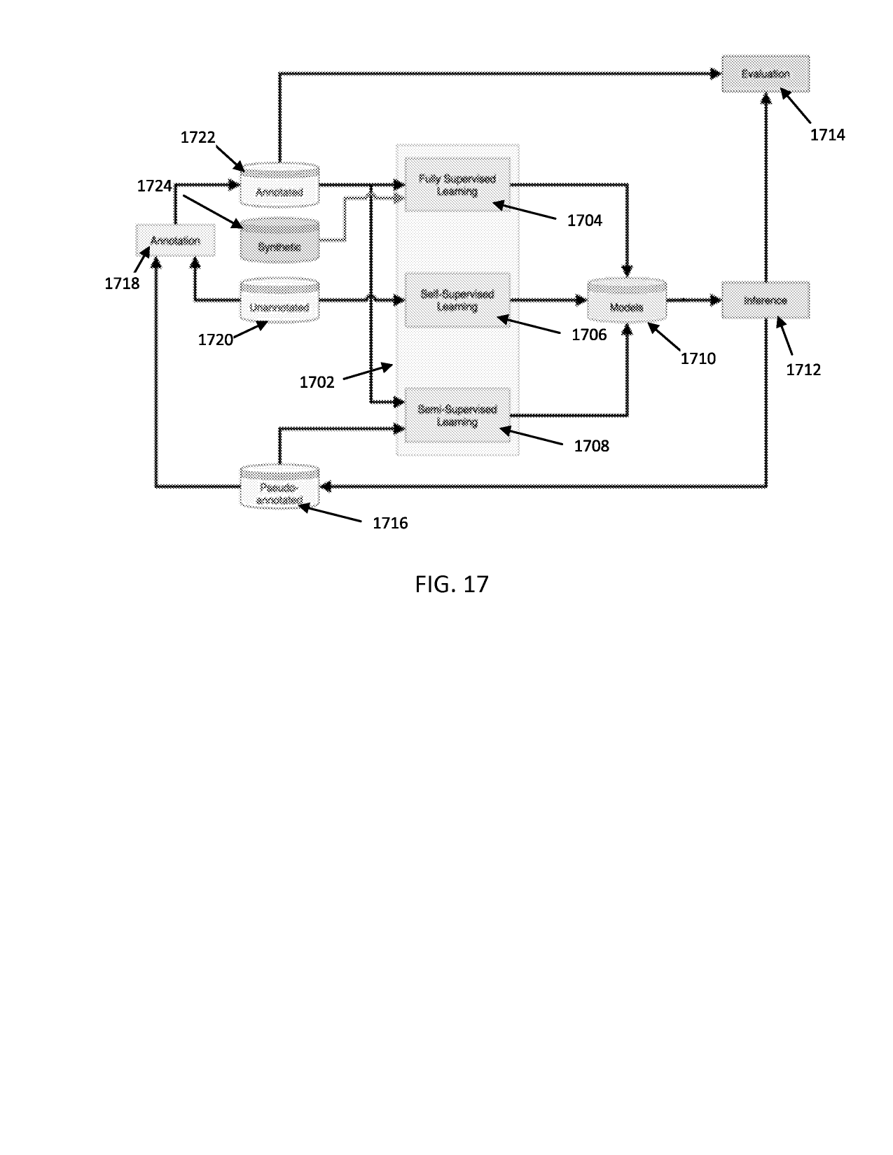

FIG. 17 represents a schematic representation of a machine learning process used to analyze images. A machine learning unit 1702 includes a full supervised learning unit 1704, a self-supervised learning unit 1706 and a semi supervised learning unit 1708. The machine learning unit 1702 feeds data from the full supervised learning unit 1704, self-supervised learning unit 1704 and semi supervised learning unit 1708 into a model analysis unit 1710. The model analysis unit 1710 generates a model based on the received data and transfers the model to an inference unit 1712. The inference unit 1712 analyzes data using the model from the model unit 1710 and transfers the analyzed data to an evaluation unit 1714. The evaluation unit 1714 evaluates the model to determine the accuracy of the model. The inference unit 1712 also sends the analyzed data to a pseudo annotation unit 1716. The pseudo annotation unit 1716 applies annotations to some of the data supplied from the inference unit 1712 and transfers the pseudo annotated data to the semi supervised learning unit 1708. The pseudo annotation unit 1716 also transfers the pseudo annotated data to an annotation unit 1718.

The annotation unit 1718 receives the pseudo annotated data and unannotated data from an unannotated data module 1720. The annotation unit 1718 combines the pseudo annotated data with the unannotated data and annotates the unannotated data to generate a complete annotated data set. The annotation unit 1718 transmits the annotated data to an annotation module 1722 that feeds the annotated data to the full supervised learning unit 1704 and to the semi supervised learning unit 1708. A synthetic data module 1724 also provides synthetic data to the full supervised learning module 1704. The self learning unit 1706 receives information from the unannotated data module 1722. The semi self learning unit 1708 receives data from the annotation module 1722 and the pseudo annotation unit 1716.

While various embodiments of the present invention have been described, it will be apparent to those of skill in the art that many more embodiments and implementations are possible that are within the scope of this invention. Accordingly, the present invention is not to be restricted except in light of the attached claims and their equivalents.

What is claimed:

1. An image analysis system having a processor and a memory, the system including:
an image gathering unit that gathers a plurality of images of an object over a predetermined period of time;
an image analysis unit that analyzes each of the plurality of images gathered by the image gathering unit;
an information gathering unit that gathers at least one type of information related to the object in the image over the predetermined period of time;
wherein,
the image analysis unit identifies at least one characteristic of the object in the image having an unknown value and determines the unknown value of the at least one characteristic by comparing known values for all characteristics of the object in the image over the predetermined period of time to at least one characteristic related to the unknown value, and
the image analysis unit generates a digital twin of the object in the image by normalizing each characteristic over the predetermined time and generating a plurality of rules for the object based on the normalized characteristics.

2. The image analysis system of claim 1, wherein the information gathering unit gathers information on at least two objects in the image.

3. The image analysis system of claim 2, wherein the information on at least one object in the image includes environmental information.

4. The image analysis system of claim 2, wherein a rule unit relates information from the gathered information to gathered images by applying at least one rule to each of the plurality of images.

5. The image analysis system of claim 4, wherein the rules applied by the rule unit are specific to each individual object.

6. The image analysis system of claim 4, wherein the rules applied by the rule unit are specific to a similar object.

7. The image analysis system of claim 4, wherein the image analysis unit modifies at least one of the plurality of images based on the rules applied.

8. The image analysis system of claim 4, wherein the image analysis unit modifies at least one of the plurality of the images of at least one object by adjusting at least one piece of information related to each of the plurality of images.

9. The image analysis system of claim 1, wherein the image analysis unit determines the type of objects in the image.

10. The image analysis system of claim 9, wherein the image analysis unit determines the orientation of each object in each of the plurality of images.

11. A method of generating a digital twin of an object in an image, the method operating on a memory and a process that perform the following steps:
gathering a plurality of images of an image of at least one object using an image gathering unit over a predetermined time period;
analyzing each of the plurality of the images of the at least one object using an image analysis unit;
gathering information related to each of the at least one object over the predetermined time using an information gathering unit;
identifying at least one characteristic of each object having an unknown value and determining the unknown value of the at least one characteristic by comparing known values for all characteristics of each object over the predetermined period of time to at least one characteristic related to the unknown value, and
generating a digital twin of the field by normalizing each characteristic over the predetermined time and generating a plurality of rules for the field based on the normalized characteristics.

12. The method of claim 11, wherein the information gathering unit gathers information on at least two objects in the image.

13. The method of claim 12, wherein the information on includes environmental information related to each of the at least one objects..

14. The method of claim 12, including the step of relating information from the gathered information to each of the plurality of gathered images by applying at least one rule to each image.

15. The method of claim 14, wherein the rules applied by the rule unit are specific to each individual object.

16. The method of claim 14, wherein the rules applied by the rule unit are specific to a similar object.

17. The method of claim 14, including the step of modifying each of the plurality of images based on the rules applied.

18. The method of claim 14, wherein the image analysis unit modifies at least one of the at lease one objects in the image by adjusting at least one piece of information related to each of the at least one objects.

19. The method of claim 11, wherein the image analysis unit determines the type of object for each of the one object in the image..

20. The method of claim 19, wherein the image analysis unit determines the orientation of the objects in the image.
